(19) United States
(12) Patent Application Publication
(10) Pub. No.: US 2016/0091747 A1
(43) Pub. Date: Mar. 31, 2016

(54) IMAGE DISPLAY APPARATUS

(71) Applicants: Kabushiki Kaisha Toshiba, Tokyo (JP); Toshiba Lifestyle Products & Services Corporation, Tokyo (JP)

(72) Inventor: Atsuhiro Koyama, Mitaka Tokyo (JP)

(21) Appl. No.: 14/625,558

(22) Filed: Feb. 18, 2015

(30) Foreign Application Priority Data
Sep. 29, 2014 (JP) 2014-198665

(51) Int. Cl. G02F 1/1333

(52) U.S. Cl. CPC G02F 1/133308; G02F 2001/13332; G02F 2001/133314; G02F 2001/133317

(57) ABSTRACT

According to one embodiment, an image display apparatus includes a front bezel having an opening, an image display panel having an image display surface exposed from the opening of the front bezel, a back chassis behind the image display panel, a shield fitting behind the back chassis, and a back cover covering the back surface of the back chassis and connected to the shield fitting.

### CROSS-REFERENCE TO RELATED APPLICATIONS

This application is based upon and claims the benefit of priority from Japanese Patent Application No. 2014-198665, filed Sep. 29, 2014, the entire contents of which are incorporated herein by reference.

### FIELD

Embodiments described herein relate generally to an image display apparatus.

### BACKGROUND

The image display apparatus has an image display panel to display images. The image display panel is housed in a case having a front bezel and a back cover.

The front bezel hitherto has an attaching portion for attaching the back cover. Therefore, when viewed from the front, the front bezel of the image display apparatus is thick.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating a liquid-crystal television in one embodiment;

FIG. 2 is a view of a partial section passing through a break line F2-F2 of the liquid-crystal television illustrated in FIG. 3;

FIG. 3 is a perspective view illustrating the back of the liquid-crystal television;

FIG. 4 is a partially sectional view taken along a break line F4-F4 of the liquid-crystal television illustrated in FIG. 3; and

FIG. 5 is a perspective view illustrating the back of the back chassis in the liquid-crystal television.

### DETAILED DESCRIPTION

Various embodiments will be described hereinafter with reference to the accompanying drawings.

In general, according to one embodiment, an image display apparatus includes a front bezel having an opening, a display panel having an image display surface exposed from the opening of the front bezel, a back chassis behind the display panel, a shield fitting behind the back chassis, and a back cover covering the back surface of the back chassis and connected to the shield fitting.

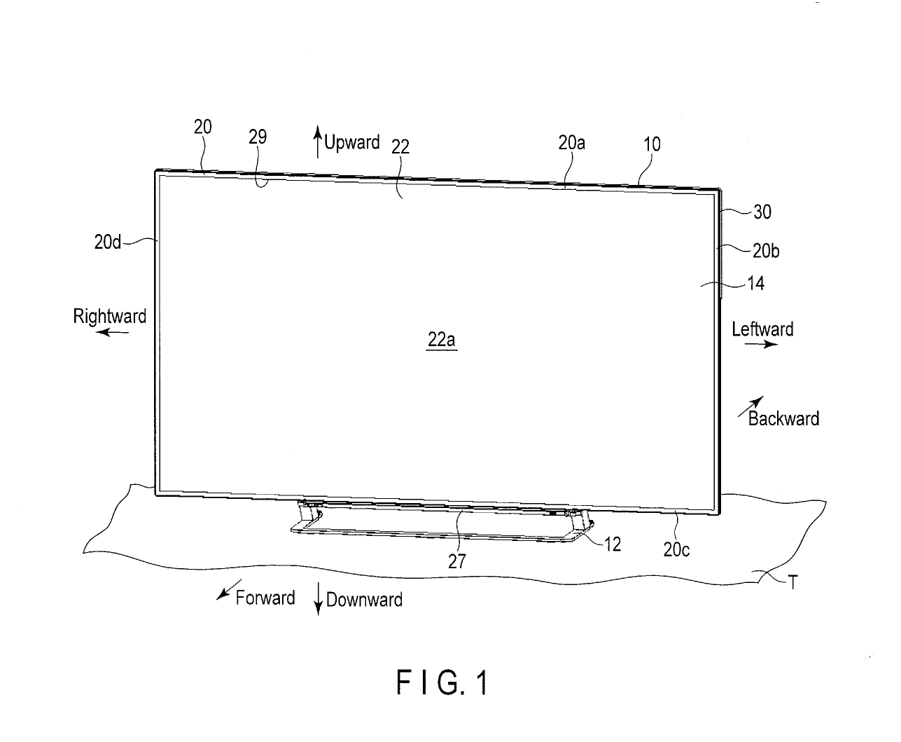

Now, one embodiment will be explained below with reference to the drawings. FIG. 1 illustrates a liquid-crystal television 10. The liquid-crystal television 10 is an exemplary image display apparatus. The liquid-crystal television 10 has a desktop rack 12 and a television body 14. The desktop rack 12 is attached to the lower portion of the television body 14. For instance, the desktop rack 12 is placed on the top plate T of the television stand, and vertically holds the television body 14 on the top plate T.

In the following explanation, it is assumed that the liquid-crystal television 10 stands in such a manner that the television body 14 is kept vertical (an image display surface 22a, which will be described later, is in a vertically extending state), and that the image display surface 22a side of the liquid-crystal television 10 is determined as a front and its opposite as a back, based on which the right and the left of the liquid-crystal television 10 are determined. Furthermore, it is assumed that the gravitational direction is determined as a downward direction of the liquid-crystal television 10, whereas the opposite of the gravitational direction as an upward direction.

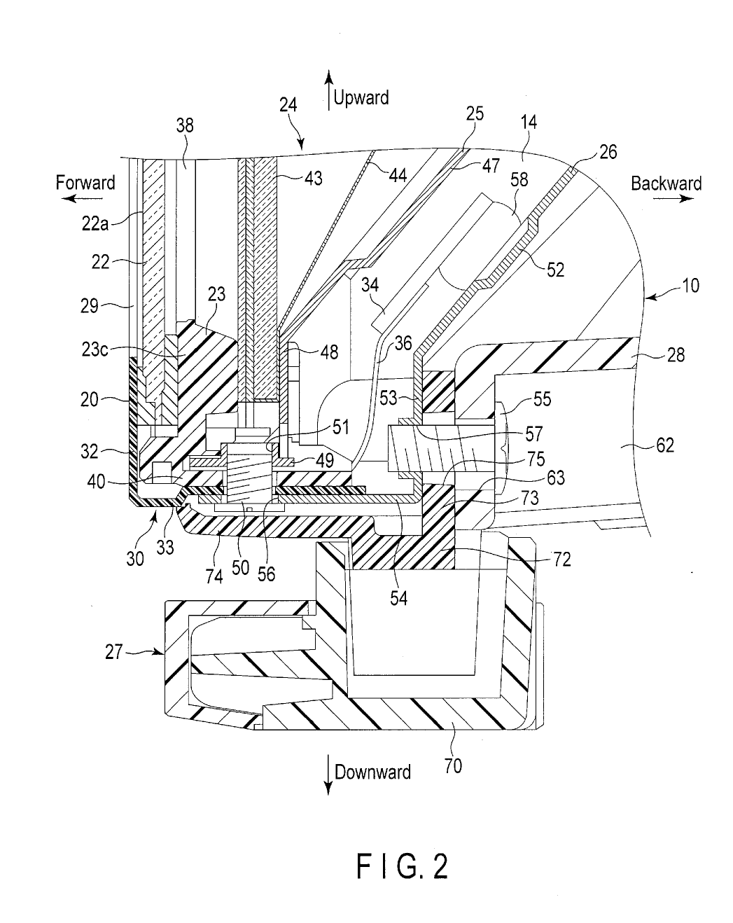

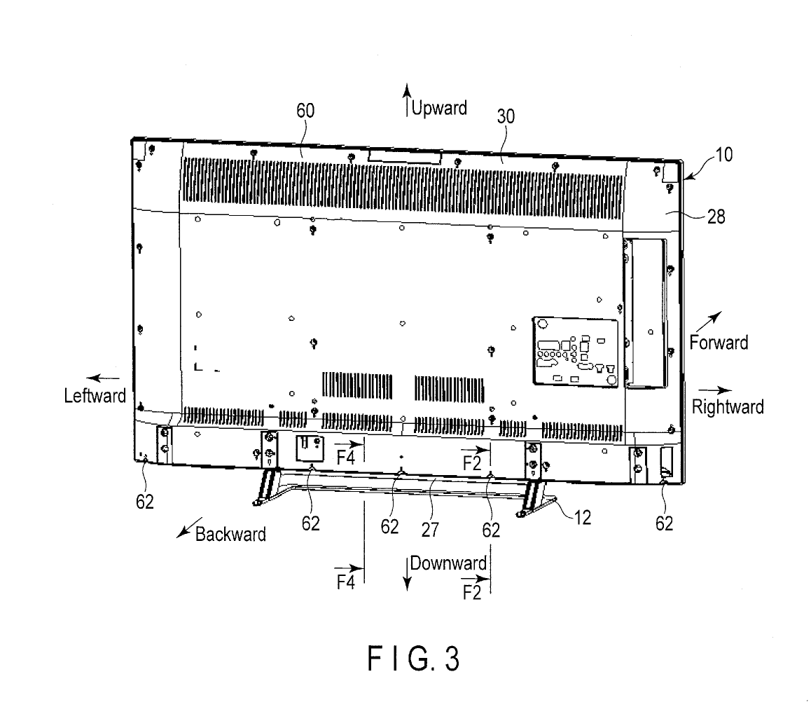

As illustrated in FIG. 2, the television body 14 includes a front bezel 20, a liquid-crystal display panel 22 used for the image display panel, a middle frame 23, a backlight module 24, a back chassis 25, a shield fitting 26, a light receiving unit 27, and a back cover 28. FIG. 2 is a view of a section obtained by cutting the liquid-crystal television 10 illustrated in FIG. 3 along a plane passing through the break line F2-F2 in FIG. 3. FIG. 2 illustrates a vertical section that is perpendicular to the back cover 28 and passes through one of attaching portions 62, which will be explained later.

The front bezel 20 and the back cover 28 are made from synthetic resin materials such as ABS resins, for instance. The front bezel 20 is attached to the front side of the television body 14. The back cover 28 is attached to the back side of the television body 14. FIG. 3 illustrates the back cover 28. The front bezel 20 and the back cover 28 constitute a case 30. The case 30 generally has a shape of a flat rectangular parallelepiped.

The front bezel 20 is a rectangular frame as illustrated in FIG. 1, and has a first border 20a, a second border 20b, a third border 20c, and a fourth border 20d. The first border 20a forms the top end of the case 30, the second border 20b the left end of the case 30, the third border 20c the bottom end of the case 30, and the fourth border 20d the right end of the case 30. Each of the borders is arranged parallel to an opposite one of the borders with a certain space in between.

The front bezel 20 has as illustrated in FIG. 2 a front plate 32 constituting the front of the case 30, and a side plate 33 surrounding the perimeter of the case 30. The front plate 32 is set to substantially meet the side plate 33 at right angles. The front plate 32 is disposed at a position opposite a viewer of the liquid-crystal television 10. The front bezel 20 has an opening 29 surrounded by and defined by the front plate 32.

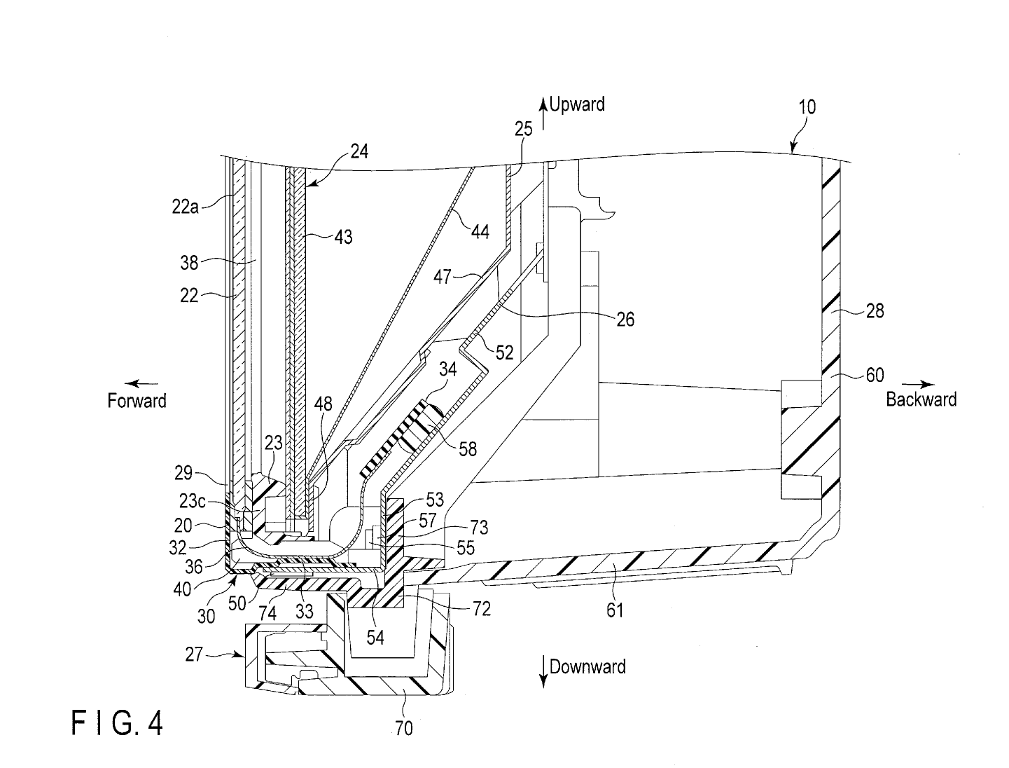

The liquid-crystal display panel 22 is behind the front bezel 20. The liquid-crystal display panel 22 is a flat rectangular parallelepiped member and has a liquid-crystal layer. As illustrated in FIG. 4, a driving board 34 is connected to the liquid-crystal display panel 22 by means of a flexible flat cable 36 for interconnections. The driving board 34 is a source substrate, for instance, or a substrate that drives the liquid-crystal layer of the liquid-crystal display panel 22. The driving board 34 is behind the back chassis 25.

The liquid-crystal display panel 22 has the image display surface 22a for displaying images in front of the liquid-crystal display panel 22. The image display surface 22a is exposed at the front of the liquid-crystal television 10 through the opening 29 of the front bezel 20. The middle frame 23 is behind the liquid-crystal display panel 22.

The middle frame 23 is made from synthetic resin materials such as ABS resins, for instance. The middle frame 23 is a rectangular frame, and has a first edge 23a, a second edge 23b, a third edge 23c, and a fourth edge 23d. It should be noted that the third edge 23c located at the bottom end of the middle frame 23 alone is illustrated in FIGS. 2 and 4.

The first edge 23a is disposed at the top end, the second edge 23b the right end, the third edge 23c the bottom end, and the fourth edge 23d the left end. The edges are connected together in a series to form a frame and define an opening 38 inside the frame. The third edge 23c at the bottom end of the middle frame 23 has feet 40 that are provided at appropriate intervals along the vertical direction of the third edge 23c. The front of the middle frame 23 adjoins the back of the liquid-crystal display panel 22. The back of the middle frame 23 adjoins the backlight module 24.

The backlight module 24 has a diffuser plate 43, a reflective plate 44 and light-emitting parts. The diffuser plate 43 is behind the liquid-crystal display panel 22 and is opposite the liquid-crystal display panel 22. The diffuser plate 43 is a member to diffuse light.

The reflective plate 44 has a reflective surface which faces the liquid-crystal display panel 22. The reflective plate 44 has a plurality of light-emitting parts. Each of the light-emitting parts has a light-emitting diode. The light-emitting parts are exposed to the liquid-crystal display panel 22 through the respective openings provided at appropriate intervals in the reflective plate 44.

The light rays radiated from the light-emitting diodes of the light-emitting parts pass through the respective openings provided at the reflective plate 44 and strike the diffuser plate 43. The light rays having been reflected from the reflective plate 44 also strike the diffuser plate 43. The light rays struck against the diffuser plate 43 are directed to the liquid-crystal display panel 22.

In this way, the light rays are radiated from the backlight module 24 to the liquid-crystal display panel 22, and thus an image displayed on the image display surface 22a of the liquid-crystal display panel 22 will be evenly irradiated with the backlight. The back chassis 25 is behind the backlight module 24.

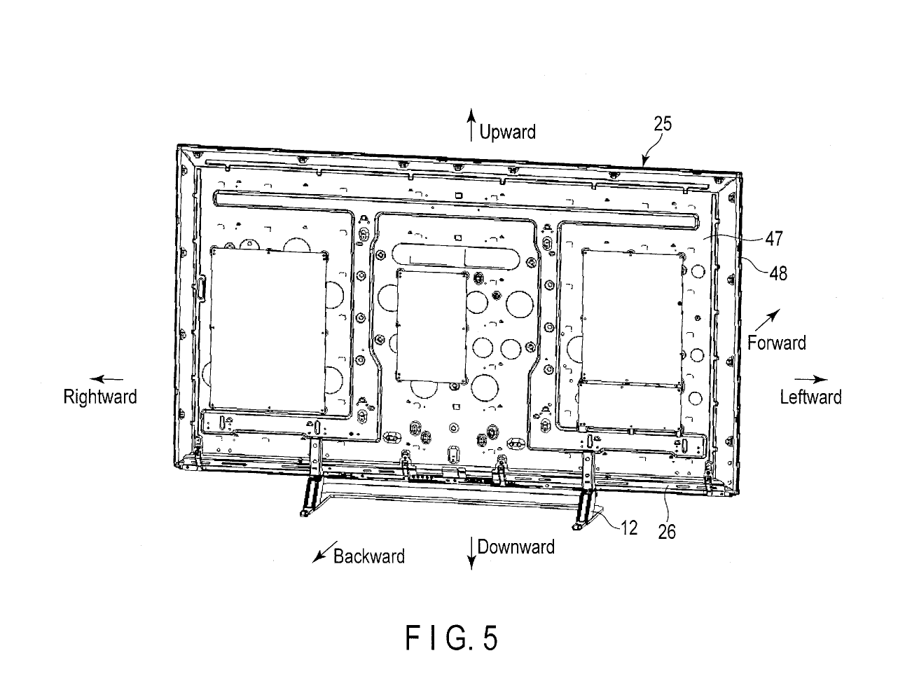

The back chassis 25 is an aluminum tabular member, for instance. The back chassis 25 has as illustrated in FIG. 5 a chassis body 47, a peripheral portion 48, and bottom ends 49 (FIG. 2).

The chassis body 47 is shaped to substantially cover the whole of the backlight module 24 and the liquid-crystal display panel 22 from behind them. The peripheral portion 48 is at the perimeter of the chassis body 47. The peripheral portion 48 is substantially parallel to the back of the backlight module 24.

The peripheral portion 48 comprises four parts individually located at the top, bottom, right and left of the chassis body 47. The bottom ends 49 are at the lower part of the peripheral portion 48. The bottom ends 49 are provided to the lower part of the peripheral portion 48 at appropriate intervals along the vertical direction of the lower part of the peripheral portion 48. The bottom ends 49 are horizontal in any direction of the right, left, front and back of the liquid-crystal television 10.

Each of the bottom ends 49 has a tapped hole 51 to which a corresponding one of second screw members 50 is screwed. The bottom ends 49, each having the tapped hole 51, are on the upper surface of a corresponding one of the feet 40 of the middle frame 23. The shield fitting 26 is behind the back chassis 25.

The shield fitting 26 is a metallic tabular member. The shield fitting 26 has a shield body portion 52, a vertical plate portion 53 and a base portion 54. As illustrated in FIG. 5, the shield fitting 26 is provided along the lower end portion of the back chassis 25, or the third border 20c of the front bezel 20.

The shield body portion 52 extends substantially parallel to the chassis body 47 of the back chassis 25 with keeping a predetermined distance to the back chassis 25. The upper portion of the shield body portion 52 is fixed to the outer surface of the back chassis 25 by means of screws, etc. The vertical plate portion 53 is at the lower portion of the shield body portion 52.

The vertical plate portion 53 is behind the peripheral portion 48 of the back chassis 25 and parallel to the peripheral portion 48 of the back chassis 25. The vertical plate portion 53 and the peripheral portion 48 define a predetermined space in between. The vertical plate portion 53 has tapped holes 57 to which first screw members 55 having passed through the back cover 28 are screwed. Every first screw member 55 has a length that will never allow its tip to reach the flexible flat cable 36 even if it is screwed to a corresponding one of the tapped holes 57. The vertical plate portion 53 is opposite the front plate 32 with the backlight module 24 in between. The vertical plate portion 53 leads to the base portion 54 at its lower part.

The base portion 54 is substantially perpendicular to the vertical plate portion 53 and horizontally extends in the right and the left direction. The base portion 54 is horizontal in any direction of the right, left, front and back of the liquid-crystal television 10. It is none other than this that the base portion extends from the vertical plate portion toward the front along the thickness directions of the image display panel. The base portion 54 has bolt holes 56 each allowing a corresponding one of the second screw members 50 to pass through. The base portion 54 is below the side plate 33 of the front bezel 20.

The driving board 34 is between the shield fitting 26 and the back chassis 25, as illustrated in FIG. 4. The driving board 34 is connected through the flexible flat cable 36 to the liquid-crystal display panel 22. Generally, a plurality of driving boards 34 are connected through the respective flexible flat cables 36 to the liquid-crystal display panel 22.

The flexible flat cable 36 is at a position avoiding the feet 40 of the middle frame 23 or at position avoiding a connecting portion where the side plate 33 of the front bezel 20 and the base portion 54 of the shield fitting 26 are connected to each other by the second screw members 50. As illustrated in FIG. 4, the flexible flat cable 36 is connected at its one end to the lower portion of the liquid-crystal display panel 22, extends from there, passes through between the lower end of the backlight module 24 and the side plate 33 of the front bezel 20, and is connected at its other end to the driving board 34. FIG. 4 is a view of a cut-out surface obtained by cutting out along break line F4-F4 the liquid-crystal television 10 illustrated in FIG. 3. FIG. 4 is a vertical sectional view illustrating a vertical section that is perpendicular to the back cover 28 and is located at a position where the attaching portions 62 are avoided. The driving board 34 and the shield fitting 26 are in electrically conductive contact with each other by means of a conductive rubber member 58. The back cover 28 is behind the shield fitting 26.

The back cover 28 has as illustrated in FIG. 3 and FIG. 4 a back cover body 60 and a peripheral wall 61. The back cover body 60 has a rectangular shape and is opposite the front bezel 20.

The peripheral wall 61 extends along the perimeter of the back cover body 60. The peripheral wall 61 projects from the upper end, lower end, right end and left end of the back cover body 60 toward the front bezel 20. The peripheral wall 61 has attaching portions 62 at its lower end portion projecting from the lower end of the back cover body 60. The attaching portions 62 are provided there at appropriate intervals as illustrated in FIG. 2 and FIG. 3.

Any of the attaching portions 62 is a space having a shape of a semi-cylinder formed by making in the peripheral wall 61 a semi-cylindrical dent recessed upward from the lower end portion of the peripheral wall 61 toward the upper side of the back cover 28, and has at its front a bolt hole 63 through which a corresponding one of the first screw members 55 passes. The back cover 28 is attached to shield fitting 26 by means of the first screw members 55, each passing through a corresponding one of the attaching portions 62 at the lower end of the back cover body 60. The light receiving unit 27 is attached to the attaching portion 62.

The light receiving unit 27 has a light-receiving body portion 70 and an attaching member 72. The light-receiving body portion 70 houses a driving circuit, a light-receiving element for receiving an infrared signal from a remote control unit of the liquid-crystal television 10, and so forth. Moreover, the light-receiving body portion 70 may have various display devices.

The attaching member 72 is firmly fixed to the light-receiving body portion 70. The attaching member 72 has an insertion piece 73 and a covering member 74. The insertion piece 73 is a thin plate member, has bolt holes 75, each allowing a corresponding one of the first screw members 55 to pass through, and is held between the back cover 28 and the vertical plate portion 53 of the shield fitting 26.

The covering member 74 extends forward from the insertion piece 73. The covering member 74 covers the head of every second screw member 50 from below when the light receiving unit 27 is attached to the back cover 28 by means of the first screw members 55.

Now, an example of how to assemble the liquid-crystal television 10 will be explained below. The backlight module 24 is attached to the back chassis 25, and the middle frame 23 is attached from the front of the backlight module 24 to the back chassis 25. The feet 40 of the middle frame 23 are disposed below the bottom ends 49 of the back chassis 25.

The liquid-crystal display panel 22 is placed in front of the middle frame 23 and the front bezel 20 is fitted to the front of the liquid-crystal display panel 22. The side plate 33 of the front bezel 20 is disposed below the feet 40 of the middle frame 23.

The shield fitting 26 is fitted from behind to the front bezel 20. The base portion 54 of the shield fitting 26 is disposed below the side plate 33 of the front bezel 20. The second screw members 50 are inserted from below into the corresponding bolt holes 56. The second screw members 50 are screwed into the corresponding tapped holes 51 at the respective bottom ends 49 of the back chassis 25.

In this way, the backlight module 24, the middle frame 23, the liquid-crystal display panel 22, the front bezel 20, and the shield fitting 26 are integrally fixed to the back chassis 25 at the lower part of the liquid-crystal television 10. The liquid-crystal display panel 22 is resiliently held between the middle frame 23 and the front plate 32 of the front bezel 20.

The attaching member 72 of the light receiving unit 27 is attached to the back side of the shield fitting 26 and the back cover 28 is fitted at the back of the attaching member 72 of the light receiving unit 27. The first screw members 55 are inserted into the respective bolt holes 63 of the back cover 28 and are screwed into the corresponding tapped holes 57 at the vertical plate portion 53. In this way, the light receiving unit 27 and the lower part of the back cover 28 are fixed through the shield fitting 26 to the back chassis 25 and the front bezel 20.

The front plate 32 of the front bezel 20 in the liquid-crystal television 10 does not have any attaching portions for fixing the first screw members 55, which makes it possible to narrow the front plate 32. Therefore, the frame will be narrow when viewed from the front of the liquid-crystal television 10.

The first screw members 55 are screwed from behind the back cover 28 into the respective attaching portions 62 provided at appropriate intervals as illustrated in FIG. 3. This makes it easy to fix the back cover 28 by means of the first screw members 55.

The front bezel 20 and the shield fitting 26 are fixed together by means of the second screw members 50 inserted from below the liquid-crystal television 10. Therefore, the fixation of the front bezel 20 will be easy.

The front bezel 20, the shield fitting 26 and the middle frame 23 are integrally fixed to the back chassis 25 by means of the second screw members 50. This makes it possible to firmly and securely fix with ease the front bezel 20, the shield fitting 26 and the middle frame 23 together.

The light receiving unit 27 is fixed by means of the insertion piece 73 inserted from below the liquid-crystal television 10 and the first screw members 55 screwed from behind the liquid-crystal television 10. This makes it possible to securely fix the light receiving unit 27 to the shield fitting 26. Moreover, it will be easy to fix the light receiving unit 27 to the liquid-crystal television 10.

When the light receiving unit 27 is attached to the back cover 28, the head of every second screw member 50 will be covered with the covering member 74. This makes it possible to make better the external appearance of the liquid-crystal television 10.

The threaded portion of each of the first screw members 55 is insufficient in length to reach the flexible flat cable 36. Therefore, the wires of the flexible flat cable 36 will not be damaged even if the first screw members 55 are screwed tight.

It is possible to extend backward the side plate 33 of the front bezel 20 while to extend forward the base portion 54 of the shield fitting 26. This makes it possible to enlarge an area where the side plate 33 and the base portion 54 overlap each other. Therefore, the front bezel 20 and the shield fitting 26 will be stably fixed.

The first screw members 55 screwed into the shield fitting 26 will never reach the flexible flat cable 36. Therefore, the positions where the respective first screw members 55 are screwed need not be aligned with the positions of the respective feet 40 of the middle frame 23. Accordingly, the attaching portions 62 may be set on any positions of the back cover 28.

Since the first screw members 55 are screwed into the metallic shield fitting 26, the back cover 28 will be firmly fixed.

The light receiving unit 27 is separate from the front bezel 20. This makes it possible to freely set the light receiving unit 27 different from the front bezel 20 in color or material properties. Furthermore, the arrangement of not placing the light receiving unit 27 below the front bezel 20 will be possible. If the liquid-crystal television 10 is not provided with the light receiving unit 27, a spacer, etc., may be provided between the back cover 28 and the shield fitting 26, for instance.

The present invention will never be limited to the above embodiment. The embodiment has been presented by way of example only, and is not intended to limit the scope of the invention. Indeed, the novel embodiment described herein may be implemented in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a front bezel having an opening;
an image display panel having a thickness and an image display surface exposed at the opening of the front bezel;
a back chassis behind the display panel, the back chassis having a back surface;
a shield fitting behind the back chassis; and
a back cover covering the back surface of the back chassis and connected to the shield fitting.

2. The image display apparatus of claim 1, wherein the shield fitting has a vertical plate portion parallel to the image display surface of the image display panel, and the back cover is connected to the vertical plate portion.

3. The image display apparatus of claim 2, wherein the shield fitting has a base portion leading to the vertical plate portion and extending forward from the vertical plate portion along the thickness of the image display panel, and the front bezel is connected to the base portion.

4. The image display apparatus of claim 2, further comprising a backlight module between the image display panel and the back chassis, wherein the back cover and the shield fitting are connected to each other by means of first screw members screwed from behind into the vertical plate portion, and the shield fitting and the backlight module define in between a space allowing the threaded portions of the respective first screw members to protrude forward from the vertical plate portion.

5. The image display apparatus of claim 3, wherein the front bezel has a front plate parallel to the image display surface of the image display panel and a side plate extending backward from the front plate, and the side plate and the base portion are connected to each other by means of second screw members each having a head and being screwed along the image display surface of the image display panel.

6. The image display apparatus of claim 5, further comprising:
a backlight module between the image display panel and the back chassis; and
a middle frame between the image display panel and the backlight module, wherein
the middle frame has a plurality of feet, and
the side plate and the base portion are connected to each other along with the feet by means of the second screw members screwed into the respective tapped holes provided at the back chassis.

7. The image display apparatus of claim 6, wherein the image display panel is connected through interconnections to a driving board provided between the shield fitting and the back chassis, and the interconnections pass through between the side plate and the backlight module at a position avoiding any connecting portions connected by the second screw members.

8. The image display apparatus of claim 7, wherein the back cover and the shield fitting are connected to each other by means of first screw members screwed from behind into the vertical plate portion, and any of the first screw members projecting forward from the vertical plate portion has a tip located behind the interconnections.

9. The image display apparatus of claim 4 or claim 8, further comprising a light receiving unit below the image display panel, the light receiving unit being connected to the shield fitting and the back cover by means of the first screw members.

10. The image display apparatus of claim 8, further comprising a light receiving unit below the image display panel, the light receiving unit being connected to the shield fitting and the back cover by means of the first screw members and having a forward extending covering member covering all the heads of the respective second screw members.
